(19) United States
(12) Patent Application Publication
(10) Pub. No.: US 2025/0233641 A1
(43) Pub. Date: Jul. 17, 2025

(54) TCI FOR CUSTOM NON-CODEBOOK-BASED BEAMS

(71) Applicant: QUALCOMM Incorporated, San Diego, CA (US)

(72) Inventors: Hamed PEZESHKI, San Diego, CA (US); Tao LUO, San Diego, CA (US); Mahmoud TAHERZADEH BOROUJENI, San Diego, CA (US); Qiaoyu LI, Beijing (CN)

(21) Appl. No.: 18/875,492

(22) PCT Filed: Jul. 20, 2022
(86) PCT No.: PCT/CN2022/106686

§ 371 Date: Dec. 16, 2024

(51) Int. Cl. H04B 7/06

(52) U.S. Cl. CPC H04B 7/06968

(57) ABSTRACT

An apparatus may be a UE or base station configured to transmit a TCI indicating a non-codebook-based beam direction based on angular information and transmit a data transmission via the non-codebook-based beam direction indicated in the TCI. In some aspects, the apparatus may be configured to receive a TCI indicating a non-codebook-based beam direction and receive a data transmission transmitted via the non-codebook-based beam direction indicated in the TCI.

### TECHNICAL FIELD

The present disclosure relates generally to communication systems, and more particularly, to a beam management and beam reporting operation.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be configured to transmit, for a wireless device, a transmission configuration indicator (TCI) indicating a non-codebook-based beam direction based on at least one of quasi-co-location (QCL) information or angular information. The apparatus may further be configured to transmit, for the wireless device, a data transmission via the non-codebook-based beam direction indicated in the TCI.

In an aspect of the disclosure, a method, a computer-readable medium, and an apparatus are provided. The apparatus may be configured to receive, from a network node, a TCI indicating a non-codebook-based beam direction and receive, from the network node, a data transmission transmitted via the non-codebook-based beam direction indicated in the TCI.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 illustrates a compressive sensing technique applied to generate a sparse matrix of gain values associated with a set of angles of departure (AoD) and a set of angles of arrival (AoA) for a communication between a UE and a base station.

FIG. 5A illustrates a set of quantized azimuthal AoD (A-AoD)/elevation AoD (Z-AoD) at a base station for a DL communication in accordance with some aspects of the disclosure.

FIG. 5B illustrates a set of quantized azimuthal AoA (A-AoA)/elevation AoA (Z-AoA) at a UE for the DL communication.

FIG. 6 is a call flow diagram illustrating a method of wireless communication in accordance with some aspects of the disclosure.

FIG. 7 is a flow diagram of a method of wireless communication.

FIG. 8 is a flow diagram of a method of wireless communication.

FIG. 9 is a flow diagram of a method of wireless communication.

FIG. 10 is a flow diagram of a method of wireless communication.

FIG. 11 is a diagram illustrating an example of a hardware implementation for an apparatus.

FIG. 12 is a diagram illustrating an example of a hardware implementation for a network entity.

### DETAILED DESCRIPTION

In some aspects of wireless communication, a pair of network devices (e.g., base stations, UEs, or other wireless devices associated with a wireless network) may communicate via a set of directional beams. The pair of network devices may include a first network device configured with a first (pre-configured and/or known) beam codebook and a second network device with a second (pre-configured and/or known) beam codebook. A beam codebook, in some aspects, may be associated with a fixed set of beam directions, such that the first beam codebook may be associated with a first number of pre-configured beam directions and a second beam codebook may be associated with a second number of pre-configured beam directions.

The pair of network devices including the first network device and the second network device, in some aspects, may select a most suitable pair of beams (e.g., beam directions) from the first beam codebook and the second beam codebook for communication between the first and second network device. The selected most suitable beam pair, in some aspects, may not represent a set of best beam directions that maximize channel gain (e.g., maximize a signal strength of communication using the best beam directions). In some aspects, the failure to select the set of best beam direction may be based on the quantization of the first and second codebook beam directions. For example, a UE may include a first beam codebook based on a set of beams with an azimuthal angle spacing of ˜90 degrees and an elevation angle spacing of ˜90 degrees that may be associated with four different beam directions (e.g., (ϕᵣ, θᵣ)={[−45, 45], [−45, 135], [45, 45], [45, 135]}). In some aspects, a base station (or other UE) may be associated with a second beam codebook with finer quantization, e.g., an azimuthal angle spacing of ˜45 degrees and an elevation angle spacing of ˜22.5 degrees that may be associated with 32 different beam directions (e.g., (ϕᵣ, θᵣ)={[−78.75, 22.5], [−78.75, 67.5], . . . , [−56.25, 112.5], . . . , [78.75, 157.5]}).

In some aspects, the granularity of the quantization may reduce a spectral efficiency of the communication below a theoretical maximal spectral efficiency. By introducing the use of non-codebook-based beams, the apparatus and method disclosed herein may provide increased spectral efficiency.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

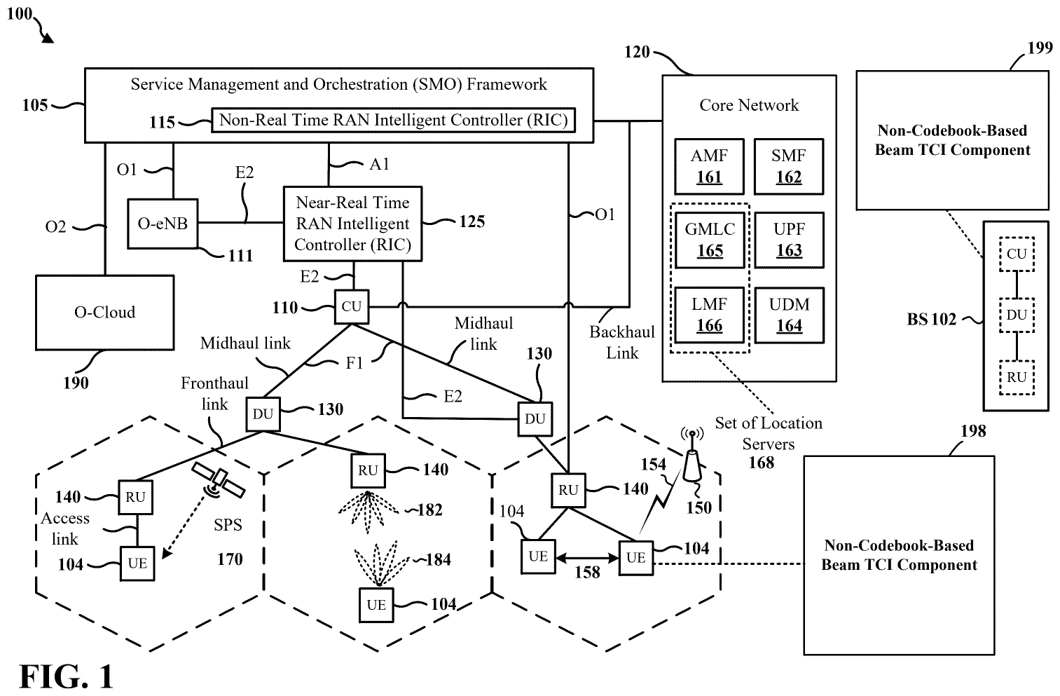

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-cNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FRI (410 MHZ-7.125 GHZ) and FR2 (24.25 GHz-52.6 GHZ). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a non-codebook-based (NCBB) TCI component 198 configured to transmit, for a wireless device, a TCI indicating a non-codebook-based beam direction based on at least one of QCL information or angular information and transmit, for the wireless device, a data transmission via the non-codebook-based beam direction indicated in the TCI. The NCBB TCI component 198, in some aspects, may be configured to receive, from a network node, a TCI indicating a non-codebook-based beam direction and receive, from the network node, a data transmission transmitted via the non-codebook-based beam direction indicated in the TCI. In certain aspects, the base station 102 may include a NCBB TCI component 199 configured to receive, from a network node, a TCI indicating a non-codebook-based beam direction and receive, from the network node, a data transmission transmitted via the non-codebook-based beam direction indicated in the TCI. The NCBB TCI component 199, in some aspects, may also be configured to transmit, for a wireless device, a TCI indicating a non-codebook-based beam direction based on at least one of QCL information or angular information and transmit, for the wireless device, a data transmission via the non-codebook-based beam direction indicated in the TCI. Although the following description may be focused on 5G NR, the concepts described herein may be applicable to other similar areas, such as LTE, LTE-A, CDMA, GSM, and other wireless technologies.

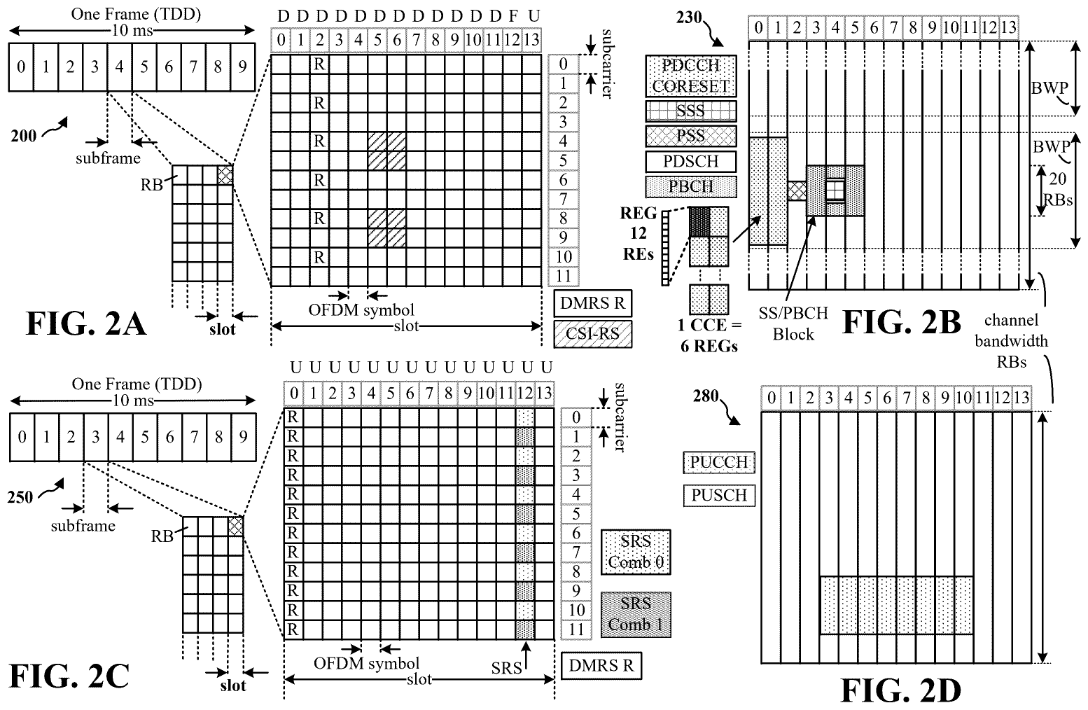

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

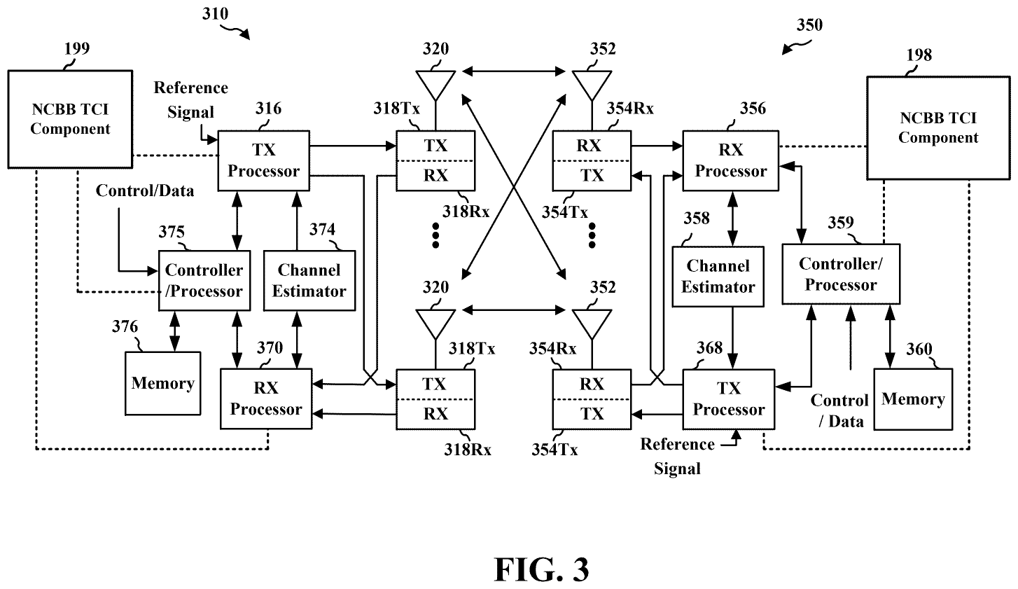

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization. The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the NCBB TCI component 198 of FIG. 1.

At least one of the TX processor 316, the RX processor 370, and the controller/processor 375 may be configured to perform aspects in connection with the NCBB TCI component 199 of FIG. 1.

In some aspects of wireless communication, a pair of network devices (e.g., base stations, UEs, or other wireless devices associated with a wireless network) may communicate via a set of directional beams. The pair of network devices may include a first network device configured with a first (pre-configured and/or known) beam codebook and a second network device with a second (pre-configured and/or known) beam codebook. A beam codebook, in some aspects, may be associated with a fixed set of beam directions, such that the first beam codebook may be associated with a first number of pre-configured beam directions and a second beam codebook may be associated with a second number of pre-configured beam directions.

The pair of network devices including the first network device and the second network device, in some aspects, may select a most suitable pair of beams (e.g., beam directions) from the first beam codebook and the second beam codebook for communication between the first and second network device. The selected most suitable beam pair, in some aspects, may not represent a set of best beam directions that maximize channel gain (e.g., maximize a signal strength of communication using the best beam directions). In some aspects, the failure to select the set of best beam direction may be based on the quantization of the first and second codebook beam directions. For example, a UE may include a first beam codebook based on a set of beams with an azimuthal angle spacing of ˜90 degrees and an elevation angle spacing of ˜90 degrees that may be associated with four different beam directions (e.g., (ϕᵣ, θᵣ)={[−45, 45], [−45, 135], [45, 45], [45, 135]}). In some aspects, a base station (or other UE) may be associated with a second beam codebook with finer quantization, e.g., an azimuthal angle spacing of ˜45 degrees and an elevation angle spacing of ˜22.5 degrees that may be associated with 32 different beam directions (e.g., (ϕᵣ, θᵣ)={[−78.75, 22.5], [−78.75, 67.5], . . . , [−56.25, 112.5], . . . , [78.75, 157.5]}).

In some aspects, the granularity of the quantization may reduce a spectral efficiency of the communication below a theoretical maximal spectral efficiency. By introducing the use of non-codebook-based beams, the apparatus and method disclosed herein may provide increased spectral efficiency.

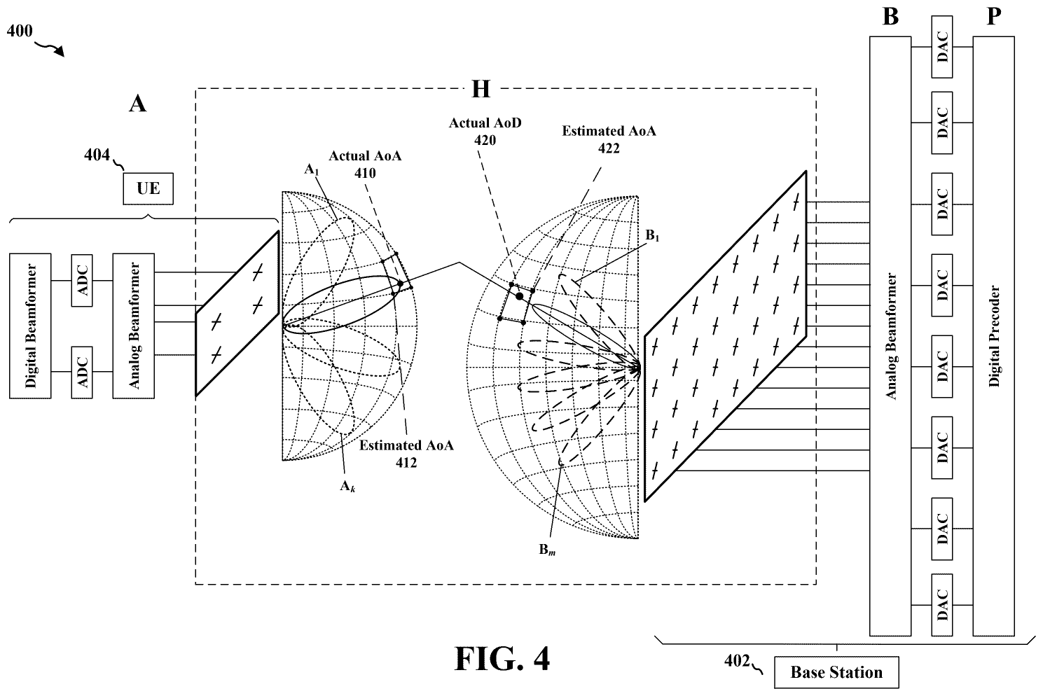

FIG. 4 is a diagram 400 illustrating a compressive sensing technique applied to generate a sparse matrix of gain values associated with a set of angles of departure (AoD) and a set of angles of arrival (AoA) for a communication between a UE 404 and a base station 402. Each AoD and AoA may be defined based on a pair of angles defined for a polar coordinate system (e.g., each AoA or AoD may be defined based on an elevation angle, ϕᵣ, and an azimuthal angle, θᵣ). The UE 404 and the base station 402 may perform a beam sweeping operation over the beam pairs including the beams, or beam directions, A₁ through Aₓ associated with the UE 404, and the beams B₁ through Bm associated with the base station 402.

The compressive sensing technique may be based on the following equation modeling the hybrid beamforming input-output relationship per-tone for downlink (a similar formulation may be used for uplink in some aspects): y=AHBPx+n, where y is an observed baseband sample, H is a raw channel matrix N_{Rx}×N_{Tx}, that is a function of core parameters such as, a number of beam clusters, a per-cluster azimuthal AoA (A-AoA), A-AOD, elevation AoA (Z-AoA), and Z-AoD, delays, and powers. Additionally, A is a Rx (analog) beamforming matrix, N_{RP}×N_{Rx}. B=Tx (analog) beamforming matrix, N_{Tx}×N_{TP}, and P is a Tx (digital) precoding matrix, N_{TP}×N_{SS}.

Using a reduced set of Tx- and Rx-beamformed measurements (AᵢHBⱼ) to collect some information about the raw channel H may allow us to predict a best beam pair (defined by an A-AoA, A-AOD, Z-AoA, and Z-AoD) with reduced overhead compared to sweeping over a more complete set of Tx- and Rx-beamformed measurements (using a larger set of Tx or Rx beams). The best beam pair may then be used to select a beam pair in the larger set of Rx and Tx beams or to define a non-codebook-based beam based on the best beam pair to increase the spectral efficiency compared to the codebook-based beam pair using the reduced set of Tx and Rx beams. In some aspects, the information about the raw channel H may be recovered based on an orthogonal matching pursuit (OMP) algorithm, where the information about the raw channel may include information regarding an actual A-AoA/Z-AoA 410, an actual A-AoD/Z-AoD 420 and a gain associated with the beam direction. The A-AoA/Z-AoA 410 and the A-AoD/Z-AoD 420 may be more accurate than an estimated AoA/Z-AoA 412 and the A-AoD/Z-AoD 422 that may have been identified without the OMP algorithm.

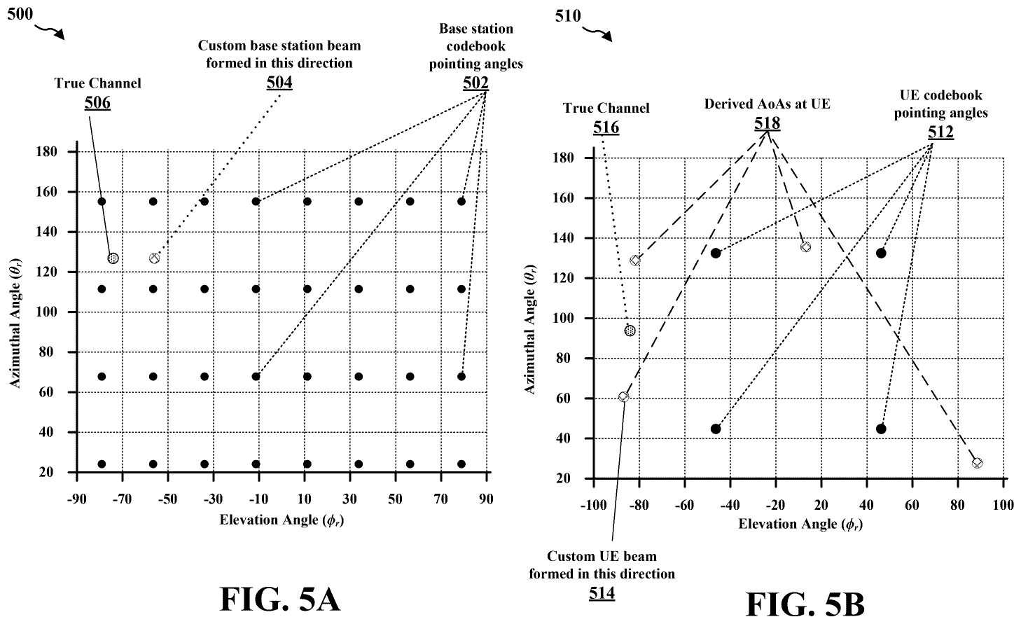

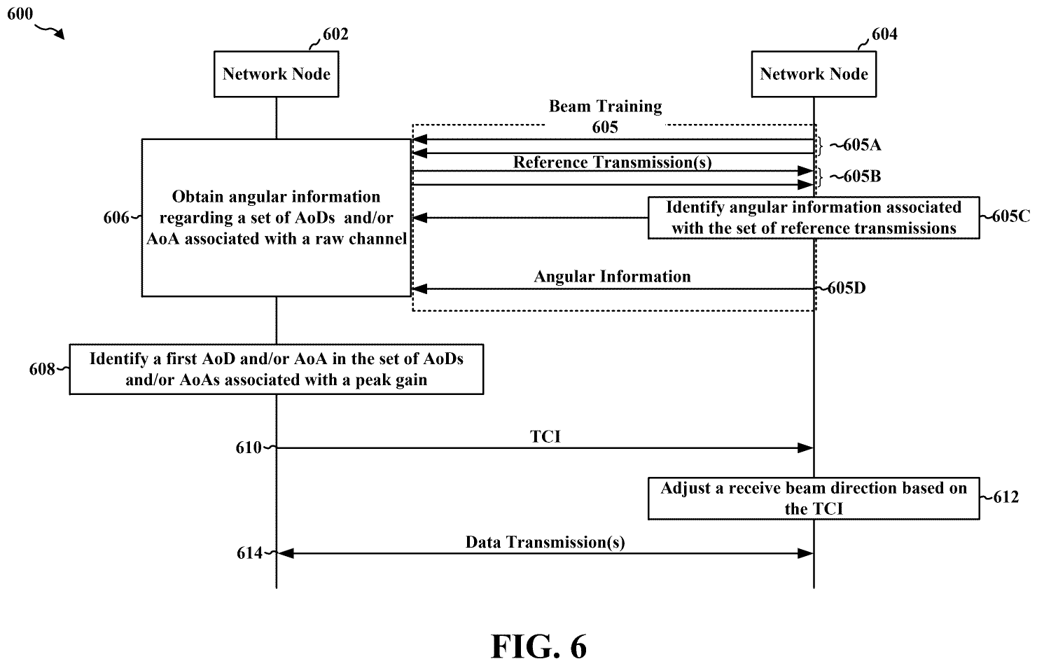

FIG. 5A is a graph 500 illustrating a set of quantized A-AoD/Z-AoD at a base station for a DL communication in accordance with some aspects of the disclosure. FIG. 5B is a graph 510 illustrating a set of quantized A-AoA/Z-AoA at a UE for the DL communication. FIGS. 5A and 5B illustrate that there may be a best beam (a true channel 506 or a true channel 516) defined by an A-AoD/Z-AoD pair for the base station or A-AoA/Z-AoA pair for the UE. The UE may also derive a set of A-AoA/Z-AoA pairs 518 based on a local beam management/beam measurement operation at the UE. The codebook-based beam directions at the base station (e.g., codebook pointing angles 502) or the codebook-based beam directions at the UE ((e.g., codebook pointing angles 512) may (and in some aspects are likely to) not coincide with a true channel 506 or 516. Based on a beam management and/or beam measurement operation as described in relation to FIG. 4, the base station and the UE may select a custom (e.g., non-codebook-based beam) beam direction 504 and/or a custom (e.g., non-codebook-based) beam direction 514 as described in relation to FIGS. 6-10 below.

FIG. 6 is a call flow diagram 600 illustrating a method of wireless communication in accordance with some aspects of the disclosure. A first network node 602 may, at 606, obtain angular information regarding a set of AoDs and/or AoAs associated with a raw channel between the first network node 602 and a second network node 604. In some aspects, the first network node 602 may be a base station and the second network node 604 may be a wireless device (e.g., a UE). The first network node 602 in some aspects, may be a wireless device (e.g., a UE) and the second network node 604 may be one of a base station or a second wireless device.

In some aspects, obtaining the angular information at 606, may include one or more components indicated in a set of beam training operations 605. In some aspects, the first network node 602 may obtain the angular information at 606 by receiving angular information 605D from the second network node 604 based on a set of beam sweeping signals (e.g., reference transmissions 605A and/or reference transmissions 605B) exchanged with the second network node 604. In some aspects, the second network node 604 may identify, at 605C, angular information associated with at least one beam direction associated with the set of reference transmissions 605B. The network node 602, in some aspects, may obtain the angular information at 606 from the network node 604 that may perform one or more compressive sensing operations (employing compressive sensing techniques). For example, the second network node 604 may receive, and measure, the reference transmissions 605B to estimate and/or identify angular information (e.g., an AoA and/or AoD). The angular information estimation and/or identification, in some aspects, may include performing a machine learning operation (e.g., an OMP algorithm) based on the set of beam sweeping signals and/or the compressive sensing to provide angular information 605D. Obtaining the angular information at 606 may, in some aspects, include identifying an AoD associated with a highest gain from the angular information 605D. In some aspects, one or more of the above operations may be performed by the first network node 602 and the second network node 604 in conjunction such that a first part of the angular information is received from the second network node 604 and a second part of the angular information is obtained by the first network node 602 performing one or more additional operations.

Based on the angular information obtained at 606, the first network node 602 may identify, at 608, a first AoD (e.g., a beam direction associated with the first AoD) and/or a first AoA (e.g., a beam direction associated with the first AoA) in the set of AoDs and/or AoAs. The identified first AoD and/or first AoA may be an AoD and/or AoA associated with a peak gain in some aspects. The first AoD and/or first AoA may be identified based on the set of reference transmissions 605A where the set of reference transmissions 605A are associated with a beam sweeping operation for transmit (Tx) beams and the first network node 602 performs a concurrent beam sweeping operation over the receive (Rx) beams to identify a gain associated with each beam pair (e.g., a pair of AoD and AoA associated with each beam pair). In some aspects, the network node 602 may identify a set of a first number of AoDs and/or AoAs associated with a set of the first number of highest gains. The set of the first number of AoDs and AoAs, in some aspects, may include codebook-based beam directions. In some aspects, the set of the first number of AoDs and AoAs may be used to determine one or more non-codebook-based beams associated with an AoD and/or an AoA for a communication between the first network node 602 and the network node 604.

The network node 602 may transmit a TCI 610 indicating a non-codebook-based beam direction (or set of beam directions) based on the angular information obtained at 606. In some aspects, the TCI 610 may refer to a set of one or more TCI states in a set of configured TCI states. The configured TCI states may indicate QCL information associated with a plurality of different beam directions. In some aspects, the TCI 610 may be tied to, and/or identified by, a channel AoD as opposed to a known reference signal QCL information to allow for non-codebook based beam direction indication. In some aspects, the indicated non-codebook-based beam direction(s) may be based on the identification at 608. As opposed to codebook-based beam directions which are selected from a configured (pre-defined) set of beam directions, non-codebook based beam directions may be selected and/or constructed based on the underlying channel. In some aspects, the selected and/or constructed non-codebook-based beam direction may provide improved performance based on being able to match the beam direction more closely to an optimal beam direction for the channel than may be achieved by a codebook-based beam direction selection.

In some aspects, the non-codebook-based beam direction is a closest suitable beam direction to the first AoD (e.g., the first AoD identified at 608). The TCI 610, in some aspects, may indicate the non-codebook-based beam direction via an indication of a first azimuthal angle associated with the non-codebook-based beam direction and a second elevation angle associated with the non-codebook-based beam direction. In some aspects, the indication of the first azimuthal angle and the second elevation angle may be indicated via a bitmap into a set of pairs of azimuthal angles and elevation angles. The bitmap may be represented, in some aspects, as a vector with each value mapped to a set of angles including an azimuthal angle and an elevation angle. In some aspects, the bitmap may be represented as a matrix with each column and row being associated with a particular angle for one of the azimuthal or the elevation angle, such that each value in the bitmap may be mapped to a set of angles including an azimuthal angle and an elevation angle. For example, the angular space may be quantized to a 2-D grid and each point in the grid may be identified with a set of bits. For instance, if the size of the 2-D grid is 256, any point may be identified by a set of 8 bits. The bitmap may be received via RRC signaling or may be known (e.g., preconfigured). The bitmap may include a set of angles that may be separated by smaller angular differences than the angles separating the codebook-based beams. The indication of the first azimuthal angle and the second elevation angle, in some aspects, may be indicated via a plurality of non-zero values in the bitmap, where each non-zero value (or set of values in a multi-bit indication) of the plurality of non-zero values is associated with a corresponding weight (e.g., a weight indicating a magnitude of a component used to determine a non-codebook-based beam direction). The corresponding weight may be indicated by a multi-bit (e.g., 2-8 bits) weight. For instance, if the size of the 2-D grid is 256, each point with a non-zero weight may be identified by a set of 8 bits and a weight associated with the point may be identified by an additional set of 2 bits to indicate a weight of, e.g., ¼, ½, ¾, or 1. In some aspects using the plurality of non-zero values to indicate the first azimuthal angle and the second elevation angle, the plurality of non-zero values in the bitmap and the corresponding weight(s) may be used (e.g., using a weighted sum) to indicate a beam direction that does not coincide with a pair of an azimuthal angle and an elevation angle in the set of pairs of the azimuthal angles and the elevation angles.

In some aspects, the TCI 610 indicates the non-codebook-based beam direction based on a QCL with a set of reference beam directions. Each reference beam direction, in some aspects, may be one of (1) a reference signal in a plurality of reference signals or (2) a configured beam direction in a plurality of configured beam directions. The set of reference beam directions, in some aspects, includes a plurality of reference beam directions and each reference beam direction in the set of reference beam directions may be associated with a corresponding weight in a set of corresponding weights. In some aspects, the plurality of reference beam directions and the set of corresponding weights are used to indicate a beam direction that does not coincide with a particular reference beam direction.

Based on the TCI 610, the second network node 604 may adjust, at 612, a receive beam used by the second network node 604. Finally, the first network node 602 and the second network node 604 may exchange data transmission(s) 614 via the beam (e.g., non-codebook-based beam) indicated in TCI 610.

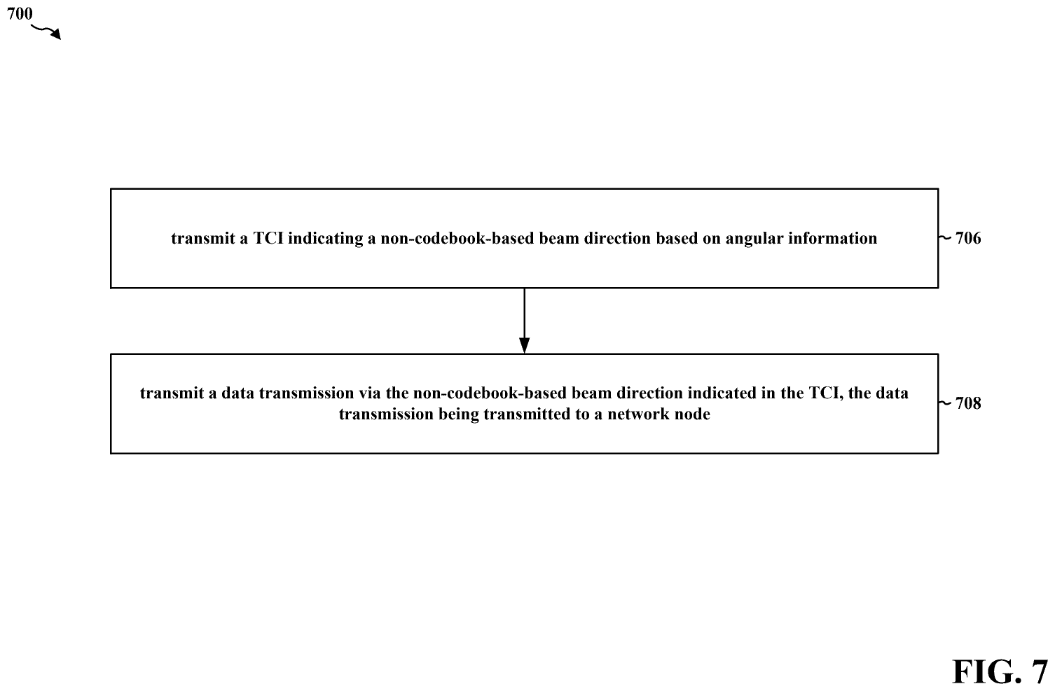

FIG. 7 is a flow diagram 700 of a method of wireless communication. The method may be performed by a network node (e.g., the network node 602 or 604), a UE (e.g., the UE 104; the apparatus 1104), or a base station (e.g., the base station 102; the network entity 1202). The network node may obtain angular information regarding a set of AoDs (and/or AoAs) associated with a raw channel. For example, referring to FIG. 6, the network node 602 may obtain, at 606, angular information regarding a set of AoDs and/or AoAs associated with a raw channel between the first network node 602 and a second network node 604.

In some aspects, to obtain the angular information, the network node may receive the angular information from another network node based on a set of beam sweeping signals exchanged with the other network node. The beam sweeping signals and/or transmissions may be part of a set of beam training and/or beam management operations as described above in relation to FIG. 6. For example, referring to FIG. 6, the second network node 604 may transmit, and the first network node may receive, angular information 605D based on the reference transmission(s) 605B.

The network node, in some aspects, may perform one or more compressive sensing operations to obtain the angular information. In some aspects, the compressive sensing operation and/or processing is preceded by a beam sweeping operation over a sparse set of AoA and AoD beam pairs that is used as described above in relation to FIGS. 4, 5A, and 5B to determine one or more of an underlying (raw) channel and an associated optimal beam direction (e.g., AoA and/or AoD). For example, referring to FIG. 6, the first network node 602 or the second network node 604, may perform a compressive sensing operation based on the set of reference transmissions 605A transmitted by the second network node 604 or the set of reference transmissions 605B transmitted by the first network node 602, respectively.

In some aspects, based on the angular information received from the other network node and/or the angular information obtained by performing the compressive sensing operation, the network node may perform a machine learning operation to obtain the angular information. The machine learning operation, in some aspects, may be an OMP algorithm. For example, the OMP algorithm may be applied to the angular information received from the other network node and/or the angular information obtained by performing the compressive sensing operation. Referring to FIG. 6, for example, the network node 602 may receive angular information 605D based on the reference transmission(s) 605B from network node 604 and/or perform a compressive sensing operation based on a set of reference transmissions 605A transmitted by the second network node 604 and apply a machine learning operation to obtain the angular information (e.g., identify channel information as described in relation to FIGS. 4-5).

The network node may identify a first AoD in the set of AoDs associated with a peak gain. In some aspects, the network node may further identify a first AoA in the set of AoAs associated with a peak gain. The first AoD and the first AoA may make up a beam pair associated with a peak gain. In some aspects, the network node may identify a set of a first number of AoDs and/or AoAs associated with a set of the first number of highest gains. The set of the first number of AoDs and AoAs, in some aspects, may include codebook-based beam directions. In some aspects, the set of the first number of AoDs and AoAs may be used to identify one or more non-codebook-based beams associated with the first AoD and/or the first AoA. For example, referring to FIG. 6, the network node 602 may identify, at 608, a first AoD (e.g., a beam direction associated with the first AoD) and/or a first AoA (e.g., a beam direction associated with the first AoA) in the set of AoDs and/or AoAs associated with a peak gain.

At 706, the network node may transmit a TCI indicating a non-codebook-based beam direction based on the angular information. For example, 706 may be performed by antenna(s) 1180 or 1280, transceivers 1122 or 1246, cellular baseband processor 1124, application processor 1106, RU processor 1242, and/or NCBB TCI component 198 or 199. In some aspects, the indicated non-codebook-based beam direction(s) may be based on the identified a first AoD in the set of AoDs associated with a peak gain. In some aspects, the non-codebook-based beam direction is a closest suitable beam direction to the first AoD (e.g., the first AoD identified at 704). The TCI, in some aspects, may indicate the non-codebook-based beam direction via an indication of a first azimuthal angle associated with the non-codebook-based beam direction and a second elevation angle associated with the non-codebook-based beam direction. In some aspects, the indication of the first azimuthal angle and the second elevation angle may be indicated via a bitmap into a set of pairs of azimuthal angles and elevation angles. The indication of the first azimuthal angle and the second elevation angle, in some aspects, may be indicated via a plurality of non-zero values in the bitmap, where each non-zero value of the plurality of non-zero values is associated with a corresponding weight. In some aspects using the plurality of non-zero values to indicate the first azimuthal angle and the second elevation angle, the plurality of non-zero values in the bitmap and the corresponding weight(s) may be used to indicate a beam direction that does not coincide with a pair of an azimuthal angle and an elevation angle in the set of pairs of the azimuthal angles and the elevation angles.

In some aspects, the TCI indicates the non-codebook-based beam direction based on a quasi-co-location with a set of reference beam directions. Each reference beam direction, in some aspects, may be one of (1) a reference signal in a plurality of reference signals or (2) a configured beam direction in a plurality of configured beam directions. The set of reference beam directions, in some aspects, includes a plurality of reference beam directions and each reference beam direction in the set of reference beam directions may be associated with a corresponding weight in a set of corresponding weights. In some aspects, the plurality of reference beam directions and the set of corresponding weights are used to indicate a beam direction that does not coincide with a particular reference beam direction. For example, referring to FIGS. 5A, 5B, and 6, the network node 602 may transmit, and network node 604 may receive, the TCI 610 that may reference one or more of a set of codebook-based beams (e.g., codebook pointing angles 502 or 512).

Finally, at 708, the network node may transmit a data transmission via the non-codebook-based beam direction indicated in the TCI transmitted at 706. In some aspects the data transmission may be transmitted to the other network node (e.g., a UE or base station). For example, 706 may be performed by antenna(s) 1180 or 1280, transceivers 1122 or 1246, cellular baseband processor 1124, application processor 1106, RU processor 1242, and/or NCBB TCI component 198 or 199. Referring to FIG. 6, for example, the network node 602 may transmit, and network node 604 may receive, data transmission(s) 614 based on the information included in the TCI 610.

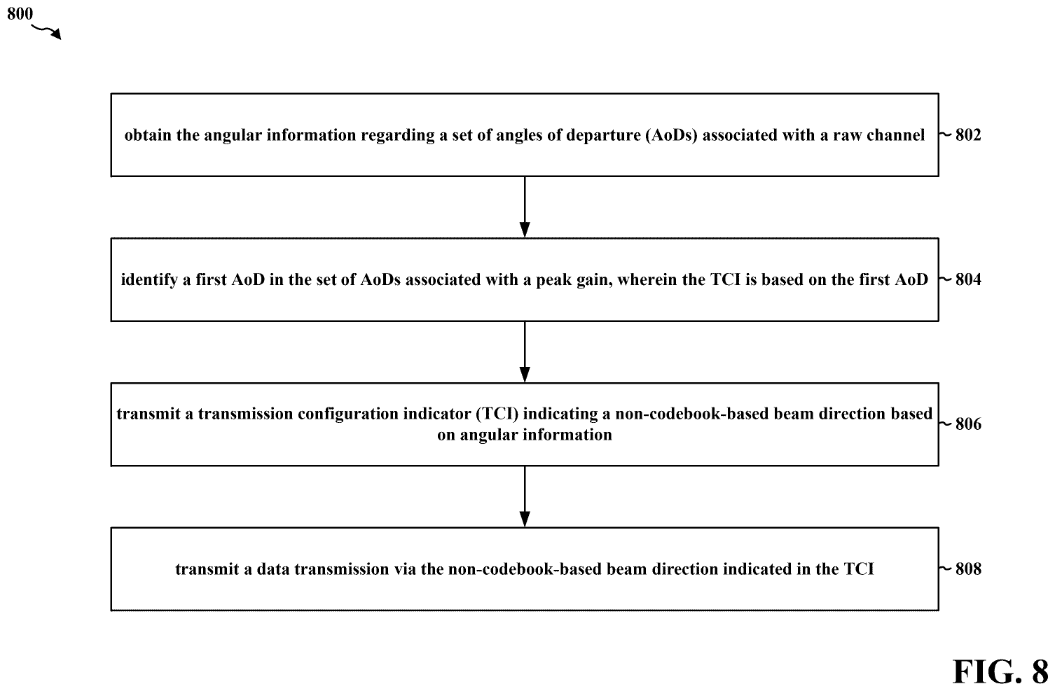

FIG. 8 is a flow diagram 800 of a method of wireless communication. The method may be performed by a network node (e.g., the network node 602 or 604), a UE (e.g., the UE 104; the apparatus 1104), or a base station (e.g., the base station 102; the network entity 1202). At 802, the network node may obtain angular information regarding a set of AoDs (and/or AoAs) associated with a raw channel. For example, 802 may be performed by antenna(s) 1180 or 1280, transceivers 1122 or 1246, cellular baseband processor 1124, application processor 1106, RU processor 1242, and/or NCBB TCI component 198 or 199. For example, referring to FIG. 6, the network node 602 may obtain, at 606, angular information regarding a set of AoDs and/or AoAs associated with a raw channel between the first network node 602 and a second network node 604.

In some aspects, to obtain the angular information at 802, the network node may receive the angular information from another network node based on a set of beam sweeping signals exchanged with the other network node. The beam sweeping signals and/or transmissions may be part of a set of beam training and/or beam management operations as described above in relation to FIG. 6. For example, referring to FIG. 6, the second network node 604 may transmit, and the first network node 602 may receive, angular information 605D based on the reference transmission(s) 605B.

At 804, the network node may identify a first AoD in the set of AoDs associated with a peak gain. In some aspects, the network node may further identify a first AoA in the set of AoAs associated with a peak gain. The first AoD and the first AoA may make up a beam pair associated with a peak gain. For example, 804 may be performed by cellular baseband processor 1124, application processor 1106, RU processor 1242, and/or NCBB TCI component 198 or 199. In some aspects, the network node may identify a set of a first number of AoDs and/or AoAs associated with a set of the first number of highest gains. The set of the first number of AoDs and AoAs, in some aspects, may include codebook-based beam directions. In some aspects, the set of the first number of AoDs and AoAs may be used to identify, at 804, one or more non-codebook-based beams associated with the first AoD and/or the first AoA. For example, referring to FIGS. 4-6, the network node 602 may identify, at 608, a first AoD (e.g., a beam direction associated with the first AoD) and/or a first AoA (e.g., a beam direction associated with the first AoA) in the set of AoDs and/or AoAs associated with a peak gain.

At 806, the network node may transmit a TCI indicating a non-codebook-based beam direction based on angular information. For example, 806 may be performed by antenna(s) 1180 or 1280, transceivers 1122 or 1246, cellular baseband processor 1124, application processor 1106, RU processor 1242, and/or NCBB TCI component 198 or 199. In some aspects, the indicated non-codebook-based beam direction(s) may be based on the identification at 804. In some aspects, the non-codebook-based beam direction is a closest suitable beam direction to the first AoD (e.g., the first AoD identified at 804). The TCI, in some aspects, may indicate the non-codebook-based beam direction via an indication of a first azimuthal angle associated with the non-codebook-based beam direction and a second elevation angle associated with the non-codebook-based beam direction. In some aspects, the indication of the first azimuthal angle and the second elevation angle may be indicated via a bitmap into a set of pairs of azimuthal angles and elevation angles. The indication of the first azimuthal angle and the second elevation angle, in some aspects, may be indicated via a plurality of non-zero values in the bitmap, where each non-zero value of the plurality of non-zero values is associated with a corresponding weight. In some aspects using the plurality of non-zero values to indicate the first azimuthal angle and the second elevation angle, the plurality of non-zero values in the bitmap and the corresponding weight(s) may be used to indicate a beam direction that does not coincide with a pair of an azimuthal angle and an elevation angle in the set of pairs of the azimuthal angles and the elevation angles.

In some aspects, the TCI indicates the non-codebook-based beam direction based on a quasi-co-location with a set of reference beam directions. Each reference beam direction, in some aspects, may be one of (1) a reference signal in a plurality of reference signals or (2) a configured beam direction in a plurality of configured beam directions. The set of reference beam directions, in some aspects, includes a plurality of reference beam directions and each reference beam direction in the set of reference beam directions may be associated with a corresponding weight in a set of corresponding weights. In some aspects, the plurality of reference beam directions and the set of corresponding weights are used to indicate a beam direction that does not coincide with a particular reference beam direction. For example, referring to FIGS. 4-6, the network node 602 may transmit, and network node 604 may receive, the TCI 610 that may reference one or more of a set of codebook-based beams (e.g., codebook pointing angles 502 or 512).

Finally, at 808, the network node may transmit a data transmission via the non-codebook-based beam direction indicated in the TCI transmitted at 806. In some aspects the data transmission may be transmitted to the other network node (e.g., a UE or base station). For example, 806 may be performed by antenna(s) 1180 or 1280, transceivers 1122 or 1246, cellular baseband processor 1124, application processor 1106, RU processor 1242, and/or NCBB TCI component 198 or 199. Referring to FIG. 6, for example, the network node 602 may transmit, and network node 604 may receive, data transmission(s) 614 based on the information included in the TCI 610.

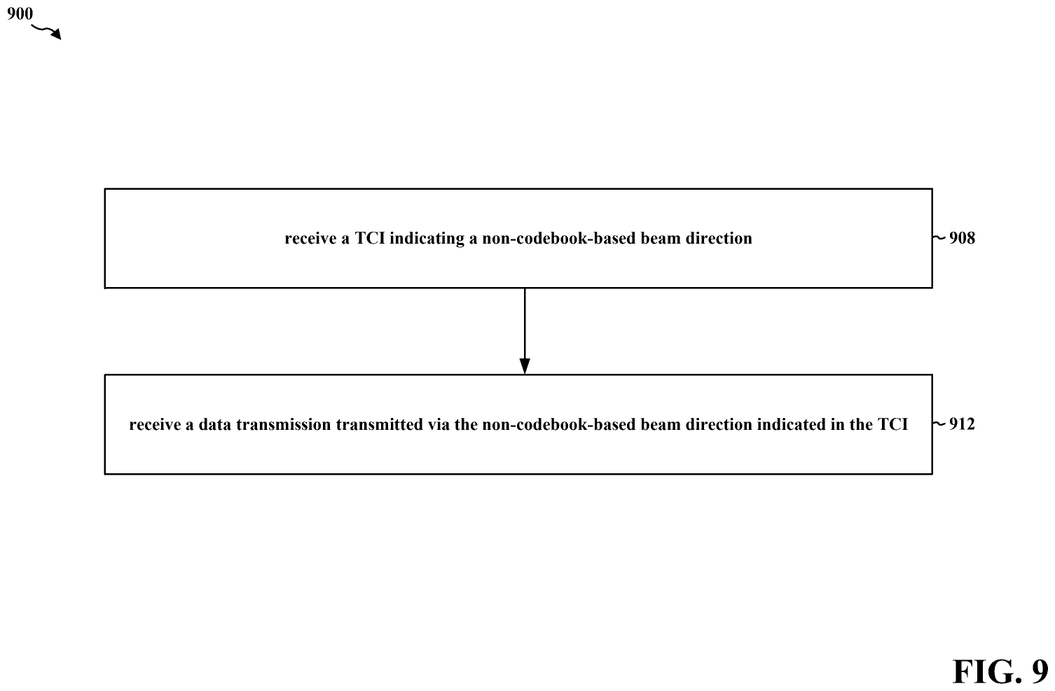

FIG. 9 is a flow diagram 900 of a method of wireless communication. The method may be performed by a network node (e.g., the network node 602 or 604), a UE (e.g., the UE 104; the apparatus 1104), or a base station (e.g., the base station 102; the network entity 1202). The network node may receive a set of reference transmissions for a beam sweeping operation. The set of reference transmissions received, in some aspects, may include a set of reference transmissions transmitted over a sparse set of transmission beams from another network node. The set of reference transmissions received at 902, in some aspects, may be received via a set of Rx beams at the network node as part of a beam sweeping operation. The set of Rx beams, in some aspects, may be a sparse set of Rx beams. For example, referring to FIG. 6, the network node 604 may receive, via a set of Rx beams, reference transmission(s) 605B transmitted via a set of Tx beams from network node 602.

In some aspects, the network node may identify angular information associated with at least one beam direction (e.g., at least one AoD and/or AoA) associated with the set of reference transmissions. The angular information may include a gain associated with the at least one beam direction and/or a set of gains associated with the set of reference transmissions (e.g., a set of gains for each pair of Tx beam and Rx beam swept by the reference transmissions). For example, referring to FIG. 6, the network node 604 may, at 605C, identify angular information associated with at least one beam direction associated with the set of reference transmissions 605B

The network node, in some aspects, may transmit the angular information to the network node. The angular information transmitted, in some aspects, may include signal strength and/or channel quality measurements for each beam in a set of beam pair swept while receiving the reference transmissions. In some aspects, the angular information may be included in a beam measurement report. For example, referring to FIG. 6, the network node 604 may transmit, and network node 602 may receive, the angular information 605D.

At 908, the network node may receive a TCI indicating a non-codebook-based beam direction. In some aspects, the TCI received at 908 may be based on the angular information transmitted at 906. For example, 908 may be performed by antenna(s) 1180 or 1280, transceivers 1122 or 1246, cellular baseband processor 1124, application processor 1106, RU processor 1242, and/or NCBB TCI component 198 or 199. In some aspects, the indicated non-codebook-based beam direction(s) may be based on the angular information associated with the at least one beam direction transmitted at 906. In some aspects, the non-codebook-based beam direction is a closest suitable beam direction to the at least one beam direction. For example, referring to FIG. 6, the network node 602 may transmit, and network node 604 may receive, the TCI 610 indicating the non-codebook-based beam direction.

The TCI, in some aspects, may indicate the non-codebook-based beam direction via an indication of a first azimuthal angle associated with the non-codebook-based beam direction and a second elevation angle associated with the non-codebook-based beam direction. In some aspects, the indication of the first azimuthal angle and the second elevation angle may be indicated via a bitmap into a set of pairs of azimuthal angles and elevation angles. The indication of the first azimuthal angle and the second elevation angle, in some aspects, may be indicated via a plurality of non-zero values in the bitmap, where each non-zero value of the plurality of non-zero values is associated with a corresponding weight. In some aspects using the plurality of non-zero values to indicate the first azimuthal angle and the second elevation angle, the plurality of non-zero values in the bitmap and the corresponding weight(s) may be used to indicate a beam direction that does not coincide with a pair of an azimuthal angle and an elevation angle in the set of pairs of the azimuthal angles and the elevation angles.

In some aspects, the TCI indicates the non-codebook-based beam direction based on a quasi-co-location with a set of reference beam directions. Each reference beam direction, in some aspects, may be one of (1) a reference signal in a plurality of reference signals or (2) a configured beam direction in a plurality of configured beam directions. The set of reference beam directions, in some aspects, includes a plurality of reference beam directions and each reference beam direction in the set of reference beam directions may be associated with a corresponding weight in a set of corresponding weights. In some aspects, the plurality of reference beam directions and the set of corresponding weights are used to indicate a beam direction that does not coincide with a particular reference beam direction. For example, referring to FIGS. 4-6, the network node 602 may transmit, and network node 604 may receive, the TCI 610 that may reference one or more of a set of codebook-based beams (e.g., codebook pointing angles 502 or 512).

In some aspects, if the network node is already in communication with the other network node, the network node may adjust a receive beam direction based on the TCI received at 908 and the angular information. For example, if the TCI indicates a beam direction (e.g., a Tx or Rx beam direction) that is different from a current beam direction, the network node may adjust a beam direction. The updated beam direction may be a non-codebook-based beam direction. Referring to FIG. 6, for example, the second network node 604 may receive TCI 610 from the first network node 602 and adjust, at 612, a receive beam used by the second network node 604.

Finally, at 912, the network node may receive a data transmission transmitted via the non-codebook-based beam direction indicated in the TCI. In some aspects, the data transmission may be received from the other network node (e.g., a UE or base station). For example, 912 may be performed by antenna(s) 1180 or 1280, transceivers 1122 or 1246, cellular baseband processor 1124, application processor 1106, RU processor 1242, and/or NCBB TCI component 198 or 199. Referring to FIG. 6, for example, the network node 604 may receive, and the network node 602 may transmit, data transmission(s) 614 based on the information included in the TCI 610.

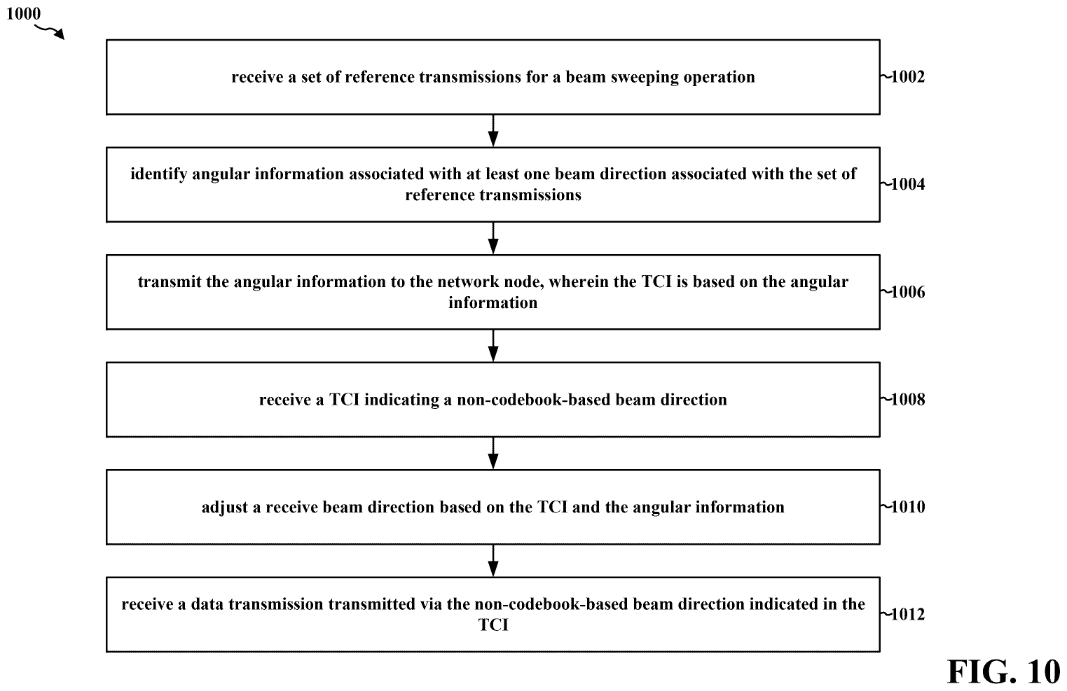

FIG. 10 is a flow diagram 1000 of a method of wireless communication. The method may be performed by a network node (e.g., the network node 602 or 604), a UE (e.g., the UE 104; the apparatus 1104), or a base station (e.g., the base station 102; the network entity 1202). At 1002, the network node may receive a set of reference transmissions for a beam sweeping operation. For example, 1002 may be performed by antenna(s) 1180 or 1280, transceivers 1122 or 1246, cellular baseband processor 1124, application processor 1106, RU processor 1242, and/or NCBB TCI component 198 or 199. The set of reference transmissions received at 1002, in some aspects, may include a set of reference transmissions transmitted over a sparse set of transmission beams from another network node. The set of reference transmissions received at 1002, in some aspects, may be received via a set of Rx beams at the network node as part of a beam sweeping operation. The set of Rx beams, in some aspects, may be a sparse set of Rx beams. For example, referring to FIG. 6, the network node 604 may receive, via a set of Rx beams, reference transmission(s) 605B transmitted via a set of Tx beams from network node 602.

At 1004, the network node may identify angular information associated with at least one beam direction (e.g., at least one AoD and/or AoA) associated with the set of reference transmissions. For example, 1004 may be performed by cellular baseband processor 1124, application processor 1106, RU processor 1242, and/or NCBB TCI component 198 or 199. The angular information may include a gain associated with the at least one beam direction and/or a set of gains associated with the set of reference transmissions (e.g., a set of gains for each pair of Tx beam and Rx beam swept by the reference transmissions). For example, referring to FIG. 6, the network node 604 may, at 605C, identify angular information associated with at least one beam direction associated with the set of reference transmissions 605B.

The network node, in some aspects, may perform one or more compressive sensing operations to identify the angular information at 1004. In some aspects, the compressive sensing operation is preceded by a beam sweeping operation over a sparse set of AoA and AoD beam pairs that is used as described above in relation to FIGS. 4, 5A, and 5B to determine one or more of an underlying (raw) channel. For example, referring to FIG. 6, the second network node 604, may perform a compressive sensing operation based on a set of reference transmissions 605B transmitted by the first network node 602.

In some aspects, based on the set of reference transmissions received at 1002 and/or the compressive sensing operations, the network node may perform a machine learning operation (e.g., an OMP algorithm) to identify the angular information at 1004. For example, the machine learning operation (e.g., the OMP algorithm) may be applied to angular information associated with the set of reference signals received at 1002 and/or the angular information obtained by performing the compressive sensing operation. Referring to FIG. 6, for example, the second network node 604 may perform a compressive sensing operation based on a set of reference transmissions 605B transmitted by the first network node 602 and apply a machine learning operation to obtain the angular information (e.g., identify channel information as described in relation to FIGS. 4-5).

At 1006, the network node may transmit the angular information to the network node. For example, 1006 may be performed by antenna(s) 1180 or 1280, transceivers 1122 or 1246, cellular baseband processor 1124, application processor 1106, RU processor 1242, and/or NCBB TCI component 198 or 199. The angular information transmitted at 1006, in some aspects, may include signal strength and/or channel quality measurements for each beam in a set of beam pair swept while receiving the reference transmissions at 1002. In some aspects, the angular information may be included in a beam measurement report. The angular information transmitted at 1006, in some aspects, may include the angular information identified by the compressive sensing operation and/or the machine learning operation. For example, referring to FIGS. 6, the network node 604 may transmit, and network node 602 may receive, the angular information 605D.

At 1008, the network node may receive a TCI indicating a non-codebook-based beam direction. In some aspects, the TCI received at 1008 may be based on the angular information transmitted at 1006. For example, 1008 may be performed by antenna(s) 1180 or 1280, transceivers 1122 or 1246, cellular baseband processor 1124, application processor 1106, RU processor 1242, and/or NCBB TCI component 198 or 199. In some aspects, the indicated non-codebook-based beam direction(s) may be based on the angular information associated with the at least one beam direction transmitted at 1006. In some aspects, the non-codebook-based beam direction is a closest suitable beam direction to the at least one beam direction. For example, referring to FIGS. 4-6, the network node 602 may transmit, and network node 604 may receive, the TCI 610 indicating the non-codebook-based beam direction.

The TCI, in some aspects, may indicate the non-codebook-based beam direction via an indication of a first azimuthal angle associated with the non-codebook-based beam direction and a second elevation angle associated with the non-codebook-based beam direction. In some aspects, the indication of the first azimuthal angle and the second elevation angle may be indicated via a bitmap into a set of pairs of azimuthal angles and elevation angles. The indication of the first azimuthal angle and the second elevation angle, in some aspects, may be indicated via a plurality of non-zero values in the bitmap, where each non-zero value of the plurality of non-zero values is associated with a corresponding weight. In some aspects using the plurality of non-zero values to indicate the first azimuthal angle and the second elevation angle, the plurality of non-zero values in the bitmap and the corresponding weight(s) may be used to indicate a beam direction that does not coincide with a pair of an azimuthal angle and an elevation angle in the set of pairs of the azimuthal angles and the elevation angles.

In some aspects, the TCI indicates the non-codebook-based beam direction based on a quasi-co-location with a set of reference beam directions. Each reference beam direction, in some aspects, may be one of (1) a reference signal in a plurality of reference signals or (2) a configured beam direction in a plurality of configured beam directions. The set of reference beam directions, in some aspects, includes a plurality of reference beam directions and each reference beam direction in the set of reference beam directions may be associated with a corresponding weight in a set of corresponding weights. In some aspects, the plurality of reference beam directions and the set of corresponding weights are used to indicate a beam direction that does not coincide with a particular reference beam direction. For example, referring to FIGS. 4-6, the network node 602 may transmit, and network node 604 may receive, the TCI 610 that may reference one or more of a set of codebook-based beams (e.g., codebook pointing angles 502 or 512).

At 1010, if the network node is already in communication with the other network node, the network node may adjust a receive beam direction based on the TCI received at 1008 and the angular information transmitted at 1006. For example, 1010 may be performed by cellular baseband processor 1124, application processor 1106, RU processor 1242, and/or NCBB TCI component 198 or 199. For example, if the TCI indicates a beam direction (e.g., a Tx or Rx beam direction) that is different from a current beam direction, the network node may adjust a beam direction. The updated beam direction may be a non-codebook-based beam direction. Referring to FIG. 6, for example, the second network node 604 may receive TCI 610 from the first network node 602 and adjust, at 612, a receive beam used by the second network node 604.

Finally, at 1012, the network node may receive a data transmission transmitted via the non-codebook-based beam direction indicated in the TCI. In some aspects, the data transmission may be received from the other network node (e.g., a UE or base station). For example, 1012 may be performed by antenna(s) 1180 or 1280, transceivers 1122 or 1246, cellular baseband processor 1124, application processor 1106, RU processor 1242, and/or NCBB TCI component 198 or 199. Referring to FIG. 6, for example, the network node 604 may receive, and the network node 602 may transmit, data transmission(s) 614 based on the information included in the TCI 610.

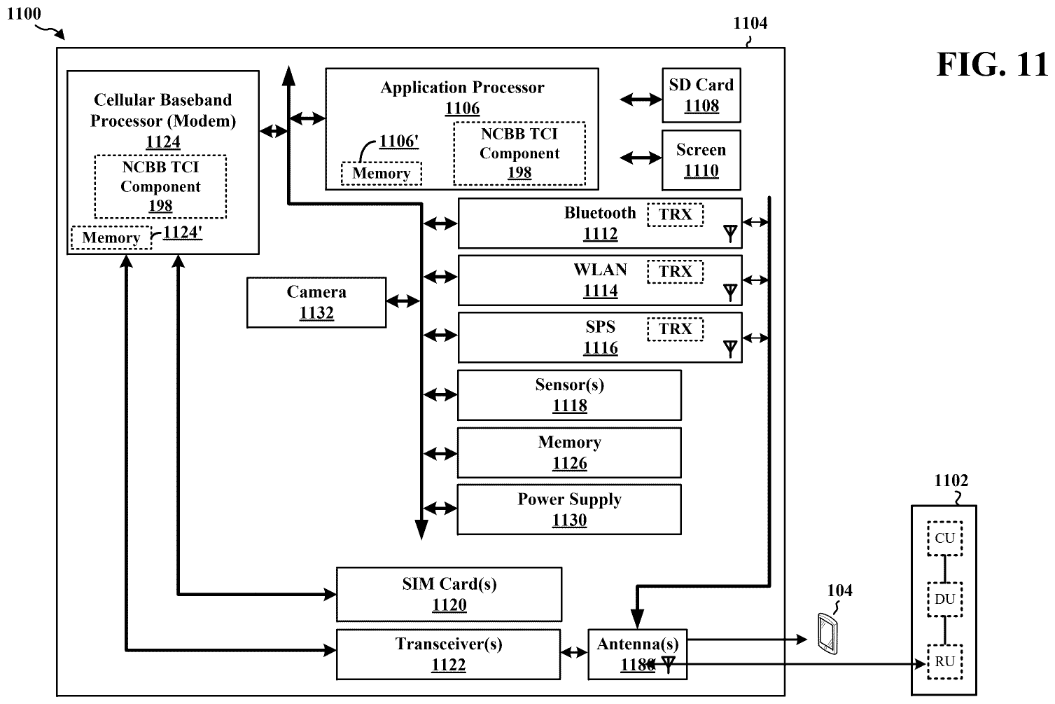

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include a cellular baseband processor 1124 (also referred to as a modem) coupled to one or more transceivers 1122 (e.g., cellular RF transceiver). The cellular baseband processor 1124 may include on-chip memory 1124′. In some aspects, the apparatus 1104 may further include one or more subscriber identity modules (SIM) cards 1120 and an application processor 1106 coupled to a secure digital (SD) card 1108 and a screen 1110. The application processor 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor 1124 communicates through the transceiver(s) 1122 via one or more antennas 1180 with the UE 104 and/or with an RU associated with a network entity 1102. The cellular baseband processor 1124 and the application processor 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor 1124 and the application processor 1106 are each responsible for general processing, including the execution of software stored on the computer-readable medium/memory. The software, when executed by the cellular baseband processor 1124/application processor 1106, causes the cellular baseband processor 1124/application processor 1106 to perform the various functions described supra. The computer-readable medium/memory may also be used for storing data that is manipulated by the cellular baseband processor 1124/application processor 1106 when executing software. The cellular baseband processor 1124/application processor 1106 may be a component of the UE 350 and may include the memory 360 and/or at least one of the TX processor 368, the RX processor 356, and the controller/processor 359. In one configuration, the apparatus 1104 may be a processor chip (modem and/or application) and include just the cellular baseband processor 1124 and/or the application processor 1106, and in another configuration, the apparatus 1104 may be the entire UE (e.g., see 350 of FIG. 3) and include the additional modules of the apparatus 1104.

As discussed supra, the NCBB TCI component 198 is configured to transmit, for a wireless device, a TCI indicating a non-codebook-based beam direction based on at least one of QCL information or angular information and transmit, for the wireless device, a data transmission via the non-codebook-based beam direction indicated in the TCI. In some aspects, the NCBB TCI component 198 may also be configured to receive, from a network node, a TCI indicating a non-codebook-based beam direction and receive, from the network node, a data transmission transmitted via the non-codebook-based beam direction indicated in the TCI. The NCBB TCI component 198 may be within the cellular baseband processor 1124, the application processor 1106, or both the cellular baseband processor 1124 and the application processor 1106. The NCBB TCI component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1104 may include a variety of components configured for various functions. In one configuration, the apparatus 1104, and in particular the cellular baseband processor 1124 and/or the application processor 1106, includes means for transmitting a TCI indicating a non-codebook-based beam direction based on angular information. The apparatus 1104 may further include means for transmitting a data transmission via the non-codebook-based beam direction indicated in the TCI, the data transmission being transmitted to a network node. The apparatus 1104 may further include means for obtaining the angular information regarding a set of AoDs associated with a raw channel. The apparatus 1104 may further include means for identifying a first AoD in the set of AoDs associated with a peak gain. The apparatus 1104 may further include means for receiving the angular information from the network node based on a set of beam sweeping signals exchanged with the network node. The apparatus 1104 may further include means for performing one or more compressive sensing techniques to obtain the angular information. The apparatus 1104 may further include means for performing a machine learning operation to obtain the angular information. The apparatus 1104 may further include means for receiving a TCI indicating a non-codebook-based beam direction. The apparatus 1104 may further include means for receiving a data transmission transmitted via the non-codebook-based beam direction indicated in the TCI, the data transmission being received from a network node. The apparatus 1104 may further include means for receiving a set of reference transmissions for a beam sweeping operation. The apparatus 1104 may further include means for identifying angular information associated with at least one beam direction associated with the set of reference transmissions. The apparatus 1104 may further include means for transmitting the angular information to the network node, where the TCI is based on the angular information. The apparatus 1104 may further include means for adjusting a receive beam direction based on the TCI and the angular information.

The means may be the NCBB TCI component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

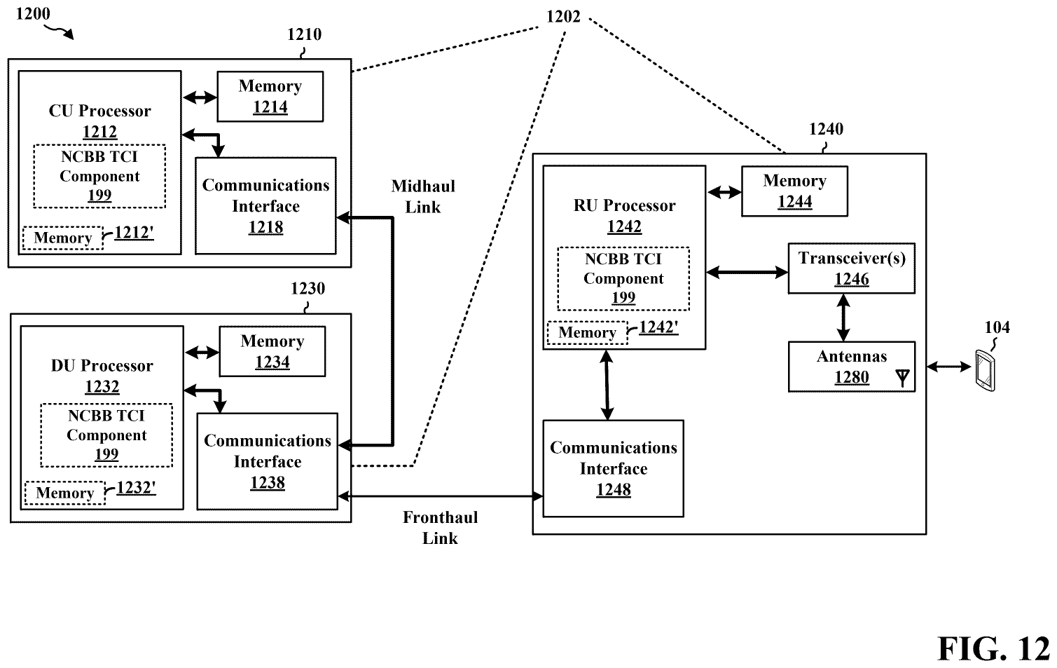

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the NCBB TCI component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include a CU processor 1212. The CU processor 1212 may include on-chip memory 1212′. In some aspects, the CU 1210 may further include additional memory modules 1214 and a communications interface 1218. The CU 1210 communicates with the DU 1230 through a midhaul link, such as an F1 interface. The DU 1230 may include a DU processor 1232. The DU processor 1232 may include on-chip memory 1232′. In some aspects, the DU 1230 may further include additional memory modules 1234 and a communications interface 1238. The DU 1230 communicates with the RU 1240 through a fronthaul link. The RU 1240 may include an RU processor 1242. The RU processor 1242 may include on-chip memory 1242′. In some aspects, the RU 1240 may further include additional memory modules 1244, one or more transceivers 1246, antennas 1280, and a communications interface 1248. The RU 1240 communicates with the UE 104. The on-chip memory 1212′, 1232′, 1242′ and the additional memory modules 1214, 1234, 1244 may each be considered a computer-readable medium/memory. Each computer-readable medium/memory may be non-transitory. Each of the processors 1212, 1232, 1242 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the NCBB TCI component 199 is configured to receive, from a network node, a TCI indicating a non-codebook-based beam direction and receive, from the network node, a data transmission transmitted via the non-codebook-based beam direction indicated in the TCI. In some aspects, the NCBB TCI component 199 may also be configured to transmit, for a wireless device, a TCI indicating a non-codebook-based beam direction based on at least one of QCL information or angular information and transmit, for the wireless device, a data transmission via the non-codebook-based beam direction indicated in the TCI. The NCBB TCI component 199 may be within one or more processors of one or more of the CU 1210, DU 1230, and the RU 1240. The NCBB TCI component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1202 may include a variety of components configured for various functions. In one configuration, the network entity 1202, includes means for receiving a TCI indicating a non-codebook-based beam direction. The network entity 1202 may further include means for receiving a data transmission transmitted via the non-codebook-based beam direction indicated in the TCI. The network entity 1202 may further include means for receiving a set of reference transmissions for a beam sweeping operation. The network entity 1202 may further include means for identifying angular information associated with at least one beam direction associated with the set of reference transmissions. The network entity 1202 may further include means for transmitting the angular information to the network node, where the TCI is based on the angular information. The network entity 1202 may further include means for adjusting a receive beam direction based on the TCI and the angular information. The network entity 1202 may further include means for transmitting a TCI indicating a non-codebook-based beam direction based on angular information. The network entity 1202 may further include means for transmitting a data transmission via the non-codebook-based beam direction indicated in the TCI, the data transmission being transmitted to a network node. The network entity 1202 may further include means for obtaining the angular information regarding a set of AoDs associated with a raw channel. The network entity 1202 may further include means for identifying a first AoD in the set of AoDs associated with a peak gain. The network entity 1202 may further include means for receiving the angular information from the network node based on a set of beam sweeping signals exchanged with the network node. The network entity 1202 may further include means for performing one or more compressive sensing techniques to obtain the angular information. The network entity 1202 may further include means for performing a machine learning operation to obtain the angular information. The means may be the NCBB TCI component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means.

In some aspects of wireless communication, a pair of network devices (e.g., base stations, UEs, or other wireless devices associated with a wireless network) may communicate via a set of directional beams. The pair of network devices may include a first network device configured with a first (pre-configured and/or known) beam codebook and a second network device with a second (pre-configured and/or known) beam codebook. A beam codebook, in some aspects, may be associated with a fixed set of beam directions, such that the first beam codebook may be associated with a first number of pre-configured beam directions and a second beam codebook may be associated with a second number of pre-configured beam directions.

The pair of network devices including the first network device and the second network device, in some aspects, may select a most suitable pair of beams (e.g., beam directions) from the first beam codebook and the second beam codebook for communication between the first and second network device. The selected most suitable beam pair, in some aspects, may not represent a set of best beam directions that maximize channel gain (e.g., maximize a signal strength of communication using the best beam directions). In some aspects, the failure to select the set of best beam direction may be based on the quantization of the first and second codebook beam directions. For example, a UE may include a first beam codebook based on a set of beams with an azimuthal angle spacing of ˜90 degrees and an elevation angle spacing of ˜90 degrees that may be associated with four different beam directions (e.g., (ϕᵣ, θᵣ)={[−45, 45], [−45, 135], [45, 45], [45, 135]}). In some aspects, a base station (or other UE) may be associated with a second beam codebook with finer quantization, e.g., an azimuthal angle spacing of ˜45 degrees and an elevation angle spacing of ˜22.5 degrees that may be associated with 32 different beam directions (e.g., (ϕᵣ, θᵣ)={[−78.75, 22.5], [−78.75, 67.5], . . . , [−56.25, 112.5], . . . , [78.75, 157.5]}).

In some aspects, the granularity of the quantization may reduce a spectral efficiency of the communication below a theoretical maximal spectral efficiency. By introducing the use of non-codebook-based beams, the apparatus and method disclosed herein may provide increased spectral efficiency.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a network node, including transmitting, for a wireless device, a TCI indicating a non-codebook-based beam direction based on at least one of QCL information or angular information and transmitting, for the wireless device, a data transmission via the non-codebook-based beam direction indicated in the TCI.

Aspect 2 is the method of aspect 1, further including obtaining the angular information regarding a set of AoDs associated with a raw channel and identifying a first AoD in the set of AoDs associated with a peak gain, where the TCI is based on the first AoD.

Aspect 3 is the method of aspect 2, where the non-codebook-based beam direction is a closest suitable beam direction to the first AoD.

Aspect 4 is the method of any of aspects 2 to 3, where obtaining the angular information regarding the set of AoDs includes one or more of: receiving the angular information from the network node based on a set of beam sweeping signals exchanged with the network node, performing one or more compressive sensing techniques to obtain the angular information, or performing a machine learning operation to obtain the angular information.

Aspect 5 is the method of any of aspects 1 to 4, where the TCI indicates the non-codebook-based beam direction via an indication of a first azimuthal angle associated with the non-codebook-based beam direction and a second elevation angle associated with the non-codebook-based beam direction.

Aspect 6 is the method of aspect 5, where the indication of the first azimuthal angle and the second elevation angle is indicated via a bitmap into a set of pairs of azimuthal angles and elevation angles.

Aspect 7 is the method of aspect 6, where the indication of the first azimuthal angle and the second elevation angle is indicated via a plurality of non-zero values in the bitmap, where each non-zero value of the plurality of non-zero values is associated with a corresponding weight, where the plurality of non-zero values in the bitmap and the corresponding weight are used to indicate a beam direction that does not coincide with a pair of an azimuthal angle and an elevation angle in the set of pairs of the azimuthal angles and the elevation angles.

Aspect 8 is the method of any of aspects 1 to 5, where the TCI indicates the non-codebook-based beam direction based on a quasi-co-location with a set of reference beam directions, where each reference beam direction comprises one of (1) a reference signal in a plurality of reference signals or (2) a configured beam direction in a plurality of configured beam directions.

Aspect 9 is the method of aspect 8, where the set of reference beam directions includes a plurality of reference beam directions and each reference beam direction in the set of reference beam directions is associated with a corresponding weight in a set of corresponding weights, where the plurality of reference beam directions and the set of corresponding weights are used to indicate a beam direction that does not coincide with a particular reference beam direction.

Aspect 10 is the method of any of aspects 1 to 9, where the wireless device is a base station, a component of the base station, a first network node, a component of the first network node, a first network entity, or a component of the first network entity.

Aspect 11 is a method of wireless communication at a wireless device, including receiving, from a network node, a TCI indicating a non-codebook-based beam direction and receiving, from the network node, a data transmission transmitted via the non-codebook-based beam direction indicated in the TCI.

Aspect 12 is the method of aspect 11, further including receiving a set of reference transmissions for a beam sweeping operation, identifying angular information associated with at least one beam direction associated with the set of reference transmissions, and transmitting the angular information to the network node, where the TCI is based on the angular information.

Aspect 13 is the method of aspect 12, where the wireless device identifies a first AoD associated with a peak gain based on the angular information, the TCI is based on the first AoD, and the non-codebook-based beam direction is a closest suitable beam direction to the first AoD.

Aspect 14 is the method of any of aspects 12 to 13, further including adjusting a receive beam direction based on the TCI and the angular information.

Aspect 15 is the method of any of aspects 11 to 14, where the TCI indicates the non-codebook-based beam direction via an indication of a first azimuthal angle associated with the non-codebook-based beam direction and a second elevation angle associated with the non-codebook-based beam direction.

Aspect 16 is the method of aspect 15, where the indication of the first azimuthal angle and the second elevation angle is indicated via a bitmap into a set of pairs of azimuthal angles and elevation angles.

Aspect 17 is the method of aspect 16, where the indication of the first azimuthal angle and the second elevation angle is indicated via a plurality of non-zero values in the bitmap, where each non-zero value of the plurality of non-zero values is associated with a corresponding weight, where the plurality of non-zero values in the bitmap and the corresponding weight are used to indicate a beam direction that does not coincide with a pair of an azimuthal angle and an elevation angle in the set of pairs of the azimuthal angles and the elevation angles.

Aspect 18 is the method of any of aspects 11 to 15, where the TCI indicates the non-codebook-based beam direction based on a quasi-co-location with a set of reference beam directions, where each reference beam direction includes one of (1) a reference signal in a plurality of reference signals or (2) a configured beam direction in a plurality of configured beam directions.

Aspect 19 is the method of aspect 18, where the set of reference beam directions includes a plurality of reference beam directions and each reference beam direction in the set of reference beam directions is associated with a corresponding weight in a set of corresponding weights, where the plurality of reference beam directions and the set of corresponding weights are used to indicate a beam direction that does not coincide with a particular reference beam direction.

Aspect 20 is the method of any of aspects 11 to 19, where the wireless device is a UE or a component of the UE.

Aspect 21 is an apparatus for wireless communication at a device including a memory and at least one processor coupled to the memory and, based at least in part on information stored in the memory, the at least one processor is configured to implement any of aspects 1 to 20.

Aspect 22 is the method of aspect 21, further including a transceiver or an antenna coupled to the at least one processor.

Aspect 23 is an apparatus for wireless communication at a device including means for implementing any of aspects 1 to 20.

Aspect 24 is a computer-readable medium (e.g., a non-transitory computer-readable medium) storing computer executable code, where the code when executed by a processor causes the processor to implement any of aspects 1 to 20.

What is claimed is:

1. An apparatus for wireless communication at a wireless device, comprising:
a memory; and
at least one processor coupled to the memory and, based at least in part on information stored in the memory, the at least one processor is configured to:
receive, from a network node, a transmission configuration indicator (TCI) indicating a non-codebook-based beam direction; and
receive, from the network node, a data transmission via the non-codebook-based beam direction indicated in the TCI.

2. The apparatus of claim 1, the at least one processor being further configured to:
receive a set of reference signal transmissions for a beam sweeping operation;
identify angular information associated with at least one beam direction associated with the set of reference signal transmissions; and
transmit the angular information to the network node, wherein the TCI is based on the angular information.

3. The apparatus of claim 2, wherein:
the wireless device identifies a first angle of departure (AoD) associated with a peak gain based on the angular information,
the TCI is based on the first AoD, and
the non-codebook-based beam direction is a closest suitable beam direction to the first AoD.

4. The apparatus of claim 2, the at least one processor being further configured to:
adjust a receive beam direction based on the TCI and the angular information.

5. The apparatus of claim 2, wherein to identify the angular information associated with the at least one beam direction, the at least one processor is configured to:
perform one or more of (1) one or more compressive sensing operations to obtain channel angular information associated with the at least one beam direction or (2) a machine learning operation to obtain the channel angular information associated with the at least one beam direction.

6. The apparatus of claim 1, wherein the TCI indicates the non-codebook-based beam direction via an indication of a first azimuthal angle associated with the non-codebook-based beam direction and a second elevation angle associated with the non-codebook-based beam direction.

7. The apparatus of claim 6, wherein the indication of the first azimuthal angle and the second elevation angle is indicated via a bitmap into a set of pairs of azimuthal angles and elevation angles.

8. The apparatus of claim 7, wherein the indication of the first azimuthal angle and the second elevation angle is indicated via a plurality of non-zero values in the bitmap, wherein each non-zero value of the plurality of non-zero values is associated with a corresponding weight, wherein the plurality of non-zero values in the bitmap and the corresponding weight are used to indicate a beam direction that does not coincide with a pair of an azimuthal angle and an elevation angle in the set of pairs of the azimuthal angles and the elevation angles.

9. The apparatus of claim 1, wherein the TCI indicates the non-codebook-based beam direction based on a quasi-co-location with a set of reference beam directions, wherein each reference beam direction comprises one of (1) a reference signal in a plurality of reference signals or (2) a configured beam direction in a plurality of configured beam directions.

10. The apparatus of claim 9, wherein the set of reference beam directions comprises a plurality of reference beam directions and each reference beam direction in the set of reference beam directions is associated with a corresponding weight in a set of corresponding weights, wherein the plurality of reference beam directions and the set of corresponding weights are used to indicate a beam direction that does not coincide with a particular reference beam direction.

11. The apparatus of claim 1, wherein the wireless device is a user equipment (UE) or a component of the UE.

12. An apparatus for wireless communication at a network node, comprising:
a memory; and
at least one processor coupled to the memory and, based at least in part on information stored in the memory, the at least one processor is configured to:
transmit, for a wireless device, a transmission configuration indicator (TCI) indicating a non-codebook-based beam direction based on at least one of quasi-co-location (QCL) information or angular information; and
transmit, for the wireless device, a data transmission via the non-codebook-based beam direction indicated in the TCI.

13. The apparatus of claim 12, the at least one processor being further configured to:
obtain the angular information regarding a set of angles of departure (AoDs) associated with a raw channel; and
identify a first AoD in the set of AoDs associated with a peak gain, wherein the TCI is based on the first AoD.

14. The apparatus of claim 13, wherein the non-codebook-based beam direction is a closest suitable beam direction to the first AoD.

15. The apparatus of claim 12, wherein the TCI indicates the non-codebook-based beam direction via an indication of a first azimuthal angle associated with the non-codebook-based beam direction and a second elevation angle associated with the non-codebook-based beam direction.

16. The apparatus of claim 15, wherein the indication of the first azimuthal angle and the second elevation angle is indicated via a bitmap into a set of pairs of azimuthal angles and elevation angles.

17. The apparatus of claim 16, wherein the indication of the first azimuthal angle and the second elevation angle is indicated via a plurality of non-zero values in the bitmap, wherein each non-zero value of the plurality of non-zero values is associated with a corresponding weight, wherein the plurality of non-zero values in the bitmap and the corresponding weight are used to indicate a beam direction that does not coincide with a pair of an azimuthal angle and an elevation angle in the set of pairs of the azimuthal angles and the elevation angles.

18. The apparatus of claim 12, wherein the TCI indicates the non-codebook-based beam direction based on a QCL with a set of reference beam directions, wherein each reference beam direction comprises one of (1) a reference signal in a plurality of reference signals or (2) a configured beam direction in a plurality of configured beam directions.

19. The apparatus of claim 18, wherein the set of reference beam directions comprises a plurality of reference beam directions and each reference beam direction in the set of reference beam directions is associated with a corresponding weight in a set of corresponding weights, wherein the plurality of reference beam directions and the set of corresponding weights are used to indicate a beam direction that does not coincide with a particular reference beam direction.

20. The apparatus of claim 12, wherein the network node is a base station, a component of the base station, a first network entity, or a component of the first network entity.

21. A method of wireless communication at a network node, comprising:
transmitting, for a wireless device, a transmission configuration indicator (TCI) indicating a non-codebook-based beam direction based on at least one of quasi-co-location (QCL) information or angular information; and
transmitting, for the wireless device, a data transmission via the non-codebook-based beam direction indicated in the TCI.

22. The method of claim 21, further comprising:
obtaining the angular information regarding a set of angles of departure (AoDs) associated with a raw channel; and
identifying a first AoD in the set of AoDs associated with a peak gain, wherein the TCI is based on the first AoD.

23. The method of claim 21, wherein the TCI indicates the non-codebook-based beam direction via an indication of a first azimuthal angle associated with the non-codebook-based beam direction and a second elevation angle associated with the non-codebook-based beam direction.

24. The method of claim 23, wherein the indication of the first azimuthal angle and the second elevation angle is indicated via a bitmap into a set of pairs of azimuthal angles and elevation angles, and the indication of the first azimuthal angle and the second elevation angle is indicated via a plurality of non-zero values in the bitmap, wherein each non-zero value of the plurality of non-zero values is associated with a corresponding weight, wherein the plurality of non-zero values in the bitmap and the corresponding weight are used to indicate a beam direction that does not coincide with a pair of an azimuthal angle and an elevation angle in the set of pairs of the azimuthal angles and the elevation angles.

25. The method of claim 21, wherein the TCI indicates the non-codebook-based beam direction based on a quasi-co-location with a set of reference beam directions, wherein each reference beam direction comprises one of (1) a reference signal in a plurality of reference signals or (2) a configured beam direction in a plurality of configured beam directions, wherein the set of reference beam directions comprises a plurality of reference beam directions and each reference beam direction in the set of reference beam directions is associated with a corresponding weight in a set of corresponding weights, wherein the plurality of reference beam directions and the set of corresponding weights are used to indicate a beam direction that does not coincide with a particular reference beam direction.

26. A method of wireless communication at a wireless device, comprising:
receiving, from a network node, a transmission configuration indicator (TCI) indicating a non-codebook-based beam direction; and
receiving, from the network node, a data transmission via the non-codebook-based beam direction indicated in the TCI.

27. The method of claim 26, further comprising:
receiving a set of reference transmissions for a beam sweeping operation;
identifying angular information associated with at least one beam direction associated with the set of reference transmissions based on performing one or more of (1) one or more compressive sensing operations to obtain channel angular information associated with the at least one beam direction or (2) a machine learning operation to obtain the channel angular information associated with the at least one beam direction, wherein the wireless device identifies a first angle of departure (AoD) associated with a peak gain based on the angular information;
transmitting the angular information to the network node, wherein the TCI is based on the first AoD and the non-codebook-based beam direction is a closest suitable beam direction to the first AoD; and
adjusting a receive beam direction based on the TCI and the angular information.

28. The method of claim 26, wherein the TCI indicates the non-codebook-based beam direction via an indication of a first azimuthal angle associated with the non-codebook-based beam direction and a second elevation angle associated with the non-codebook-based beam direction.

29. The method of claim 28, wherein the indication of the first azimuthal angle and the second elevation angle is indicated via a bitmap into a set of pairs of azimuthal angles and elevation angles, and the indication of the first azimuthal angle and the second elevation angle is indicated via a plurality of non-zero values in the bitmap, wherein each non-zero value of the plurality of non-zero values is associated with a corresponding weight, wherein the plurality of non-zero values in the bitmap and the corresponding weight are used to indicate a beam direction that does not coincide with a pair of an azimuthal angle and an elevation angle in the set of pairs of the azimuthal angles and the elevation angles.

30. The method of claim 26, wherein the TCI indicates the non-codebook-based beam direction based on a quasi-co-location with a set of reference beam directions, wherein each reference beam direction comprises one of (1) a reference signal in a plurality of reference signals or (2) a configured beam direction in a plurality of configured beam directions, wherein the set of reference beam directions comprises a plurality of reference beam directions and each reference beam direction in the set of reference beam directions is associated with a corresponding weight in a set of corresponding weights, wherein the plurality of reference beam directions and the set of corresponding weights are used to indicate a beam direction that does not coincide with a particular reference beam direction.
